(19) United States
(12) Patent Application Publication
(10) Pub. No.: US 2003/0001744 A1
(43) Pub. Date: Jan. 2, 2003

(54) Communication tool and communication support system

(76) Inventors: Takashi Mizokawa, Shizuoka (JP); Masyuki Mizukami, Shizuoka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/173,454

(22) Filed: Jun. 14, 2002

(30) Foreign Application Priority Data
Jun. 14, 2001 (JP) 2001-180516

(51) Int. Cl. G08B 23/00

(52) U.S. Cl. 340/573.1

(57) ABSTRACT

A communication tool includes a expression data storage section 107 for storing information with regard to a motion device 113 that the user directly moves, a communication control section 101 for transmitting expression data stored in the expression data storage section 107 and receiving the transmitted information from the other communication robot 3 to make the expression data storage section 107 store it, and a motion device control section 111 for operating the motion device 113 based on the expression data stored in the expression data storage section 107.

### BACKGROUND OF THE INVENTION

1. Field of the Invention

The present invention relates to a communication tool and a communication support system for use in communication between remote locations.

2. Description of the Related Art

Conventionally, there have been known some communication tools, such as a telephone with voices, e-mail with characters and a videophone with voices and images.

However, all the conventional communication tools described above were those without any substance, so that users often got into frustration as the actual feelings were lacked.

An object of the present invention is to solve the problems in the conventional communication tool as described above and to provide a communication tool and a communication support system with which users may have actual feelings fully.

### SUMMARY OF THE INVENTION

The present invention can achieve at least the above object among others. In an embodiment, the present invention provides a communication tool comprising: (i) a motion device which is physically movable by a user and provides signals corresponding to its movement; (ii) a transmitting information storage for storing the signals; (iii) a transmitter for transmitting the signals stored in the transmitting information storage to another communication tool; (iv) a receiver for receiving signals transmitted from another communication tool; (v) a received information storage for storing the received signals by the receiver; and (vi) a motion reproduction unit for activating the motion device based on the received signals stored in the received information storage.

In an embodiment, the communication tool further comprises a behavior control unit provided a position between the motion device and the transmitting information storage, between the motion reproduction unit and the received information storage, between the transmitter and the transmitting information storage, and between the receiver and the receiving information storage, so that all signals pass through the behavior control unit which controls flow of the signals.

In the above, the communication tool may further comprise an environment detection unit for detecting environmental information including the user's designated motion, said environment detection unit being connected to the behavior control unit, said behavior control unit being configured to activate the motion reproduction unit when the user's designated Motion is detected.

Further, the communication tool may further comprise an environment detection unit for detecting environmental information including signals inputted by the user, said environment detection unit being connected to the behavior control unit, said behavior control unit being configured to activate the motion reproduction unit when the user's signals are received.

In another embodiment, the communication tool may further comprise an environment detection unit for detecting environmental information including ambient temperature and brightness, said environment detection unit being connected to the behavior control unit, said behavior control unit being configured to transmit the environmental information.

In yet another embodiment, the communication tool may further comprise a mode selection unit for selecting an autonomous mode for activating the motion reproduction unit autonomously or an expression transmission mode for following the user's commands, wherein the behavior control unit includes the autonomous mode and the expression transmission mode.

In still another embodiment, the communication tool further comprise an operation command input unit for selecting one operation from (i) signal receiving processing, (ii) signal transmitting processing, or (iii) motion reproduction processing, in the expression transmission mode, wherein the expression transmission mode of the behavior control unit includes the signal receiving processing, the signal transmitting processing, and the motion reproduction processing.

Additionally, in an embodiment, the behavior control unit is configured to output information stored in the transmitting information storage to the motion reproduction unit to activate the motion device.

Further, the behavior control unit may be configured to access an external memory unit to save information stored in either of the transmitting information storage or the received information storage or provide information to either of the transmitting information storage or the received information storage.

In another aspect, the present invention can equally be applied to a communication method.

Further, the present invention includes a communication support system as described below.

For purposes of summarizing the invention and the advantages achieved over the prior art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention.

FIG. 1a is a block diagram showing an embodiment of the communication support system according to the present invention.

FIG. 1b is a block diagram showing another embodiment of the communication support system according to the present invention.

FIG. 1c is a block diagram showing an entire constitution of an embodiment of the communication support system according to the present invention.

FIG. 2 is a flowchart of arithmetic processing of the control program executed in the communication robot of FIG. 1c.

FIG. 3 is a flowchart of the expression transmission control process executed in the arithmetic processing of FIG. 2.

Symbols used in the figures are, for example, as follows: 1: Communication line; 2: Terminal device; 3: Communication robot; 100: Com interface; 101: Communication control section; 102: Input device; 103: Recognition section; 104: Mode switching control section; 105: Mode switching device; 106: Behavior control section; 107: Expression data storage section; 108: Removable storage device control section; 109: Removable storage device interface; 110: Expression transmission operating device; 111: Motion device control section; 112: Expression database; 113: Motion device; 114: Expression transmission control section; 115: Autonomous behavior control section; 116: Expression input control section; 117: Expression output control section; 118: Expression reproduction control section; 119: Removable storage device.

### DETAILED DESCRIPTION OF THE PREFERRED EMBODIMENT

The present invention includes, but is not limited to, the following various embodiments:

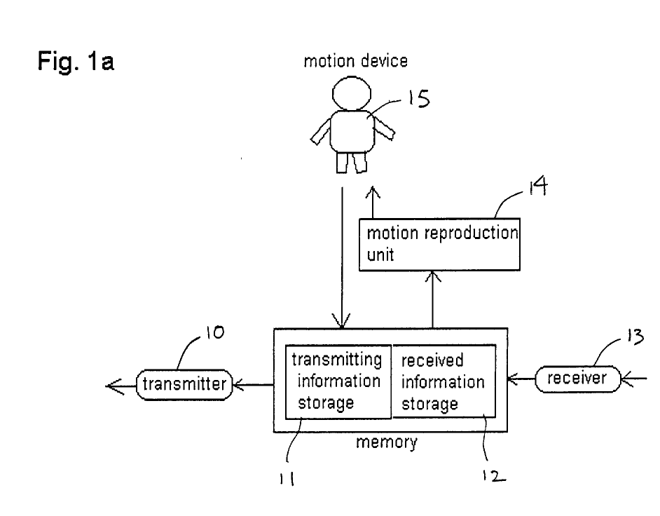

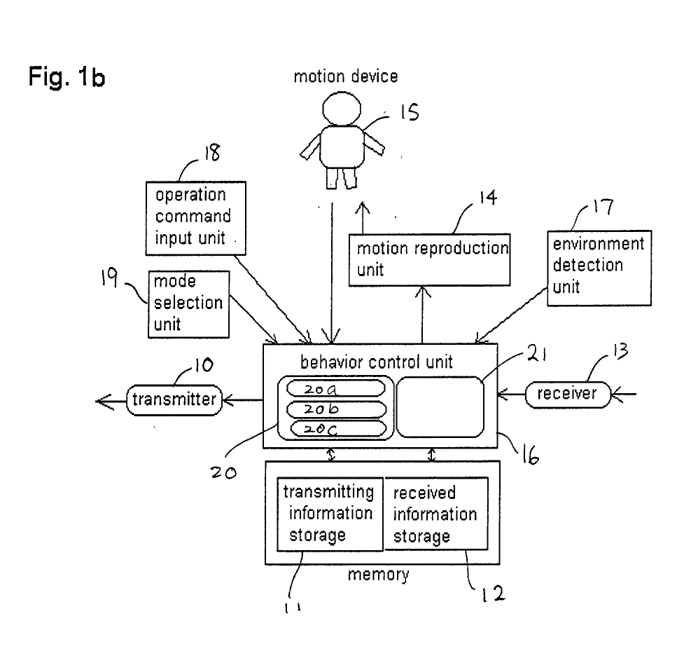

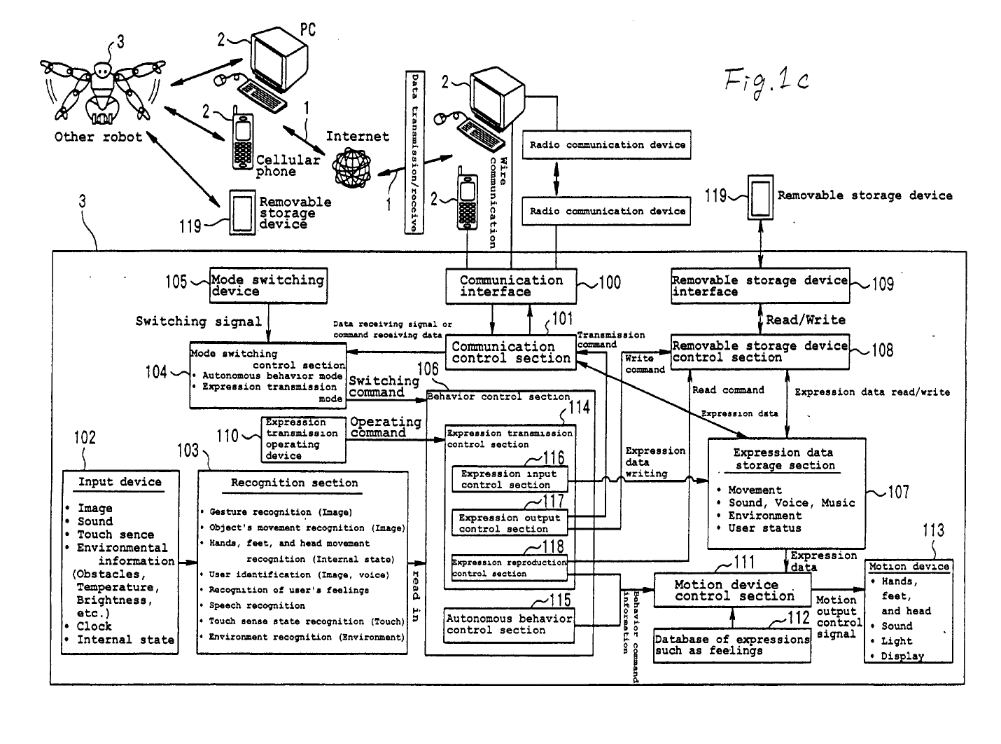

As shown in FIG. 1a, in an embodiment, the present invention provides a communication tool comprising: (i) a motion device 15 which is physically movable by a user and provides signals corresponding to its movement; (ii) a transmitting information storage 11 for storing the signals; (iii) a transmitter 10 for transmitting the signals stored in the transmitting information storage to another communication tool; (iv) a receiver 13 for receiving signals transmitted from another communication tool; (v) a received information storage 12 for storing the received signals by the receiver; and (vi) a motion reproduction unit 14 for activating the motion device based on the received signals stored in the received information storage. By using this tool, the user can make more sensory communicate with other users than conventional means. The signals transmitted or received by the tool can be accomplished through a communication interface. The transmitting information storage and the received information storage can be stored in respective separate memories or in a common memory using different sections. Communication tools which can be communicated each other can be of the same type or of different types, as long as a basic schematic is the same. For example, a different motion device can be used, so that when a leg of one motion device is moved, a caterpillar of another motion device will move. The motion device can be of a humanoid type, a pet type (dog, cat, etc.), any monster figures, or any other three-dimensional figures or objects. Each movable portion is equipped with a sensor transmitting a signal.

As shown in FIG. 1b, in an embodiment, the communication tool further comprises a behavior control unit 16 provided a position between the motion device 15 and the transmitting information storage 11, between the motion reproduction unit 14 and the received information storage 12, between the transmitter 10 and the transmitting information storage 11, and between the receiver 13 and the receiving information storage 12, so that all signals pass through the behavior control unit 16 which controls flow of the signals.

In the above, the communication tool may further comprise an environment detection unit 17 for detecting environmental information including the user's designated motion. The environment detection unit 17 is connected to the behavior control unit 16, and the behavior control unit 16 is configured to activate the motion reproduction unit 14 when the user's designated motion is detected.

In another embodiment, the environment detection unit 17 is configured to detect environmental information including signals inputted by the user. Additionally, in another embodiment, the environment detection unit 17 is configured to detect environmental information including ambient temperature and brightness.

In yet another embodiment, the communication tool may further comprise a mode selection unit 19 for selecting an autonomous mode for activating the motion reproduction unit autonomously or an expression transmission mode for following the user's commands, wherein the behavior control unit 16 includes the autonomous mode 21 and the expression transmission mode 20.

In still another embodiment, the communication tool further comprise an operation command input unit 18 for selecting one operation from (i) signal receiving processing, (ii) signal transmitting processing, or (iii) motion reproduction processing, in the expression transmission mode 20, wherein the expression transmission mode 20 of the behavior control unit 16 includes the signal receiving processing 20a, the signal transmitting processing 20b, and the motion reproduction processing 20c.

When the tool is set in the autonomous mode, emotions can be used. Any suitable emotion control techniques can be adapted to this invention, including U.S. Pat. No. 6,175,772 (issued Jan. 16, 2001), U.S. Pat. No. 6,230,111 (issued May 8, 2001, and U.S. Pat. No. 6,249,780 (issued Jun. 19, 2001, and U.S. patent application Ser. No. 09/393,146 (filed Sep. 10, 1999), U.S. Ser. No. 09/393,247 (filed Sep. 10, 1999), and U.S. Ser. No. 09/394,369 (filed Sep. 10, 1999). The disclosure of each reference in its entirety is incorporated herein by reference. Emotion control can also be applied when in the expression transmitting mode.

Additionally, in an embodiment, the behavior control unit is configured to output information stored in the transmitting information storage to the motion reproduction unit to activate the motion device, so that the user can activate the motion device to reproduce the motion the user previously made.

The present invention further includes the following embodiments:

1) A communication tool characterized by comprising: (i) a moving section; (ii) a transmitting information storage means for storing information relating to the moving section directly moved by a user; (iii) a transmission means for transmitting the information stored in the transmitting information storage means; (iv) a receiving means for receiving the information transmitted from other communication tools; (v) a received information storage means for storing the information received by the receiving means; and (vi) a reproduction means for moving the moving section based on the information stored in the received information storage means.

2) A communication tool according to item 1, wherein the receiving means comprises a reception notifying means for notifying that the receiving means received the information.

3) A communication tool according to item 1 or 2, comprising a detection means for detecting the specific movement of the user, wherein the reproduction means is adapted to move the moving section based on the information stored in the received information storage means, when the receiving means receives the information and when the detection means detects the specific movement.

4) A communication tool according to any one of items 1-3, wherein the transmission means is adapted to transmit an execution command, and the reproduction means is adapted to move the moving section based on the information stored in the received information storage means when the receiving means receives the execution command.

5) A communication tool according to any one of items 1-4, further comprising a mode switching means for selectively switching an autonomous mode and an expression transmission mode.

6) A communication tool according to item 5, wherein the mode switching means is adapted to switch to the expression transmission mode when the receiving means receives the information.

7) A communication tool according to any one of items 1-6, further comprising a transmission commanding means for making the transmission means start transmission based on a command of the user.

8) A communication tool characterized by comprising: (i) a moving section; (ii) a storage means for storing information relating the moving section directly moved by a user; and (iii) a reproduction means for moving the moving section based on the information stored in the storage means.

9) A communication tool according to any one of items 1-8, further comprising an environmental information acquisition means for acquiring information relating to a peripheral environment, wherein the transmitting information storage means is also adapted to store the information acquired by the environmental information acquisition means.

10) A communication tool according to any one of items 1-9, further comprising a gesture information acquisition means for acquiring information relating to the gestures of the user, wherein the transmitting information storage means is also adapted to store the information acquired by the gesture information acquisition means.

11) A communication tool according to any one of items 1-10, comprising a feeling information acquisition means for acquiring information relating to feelings of the user, wherein the transmitting information storage means is also adapted to store the information acquired by the feeling information acquisition means.

12) A communication tool according to any one of items 1-11, further comprising a music reproduction means capable of reproducing music data, wherein the transmitting information storage means is adapted to store the music data, and the reproduction means is adapted to make the music reproduction means reproduce the music data as well as move the moving section, based on the information stored in the received information storage means.

13) A communication tool according to any one of items 1-12, further comprising a voice recording means for recording the voice spoken by the user and a voice reproduction means capable of reproducing the voice, wherein the transmitting information storage means is also adapted to store the voice recorded with the voice recording means, and the reproductopn means is adapted to make the voice reproduction means reproduce the voice based on information stored in the received information storage means as well as to move the moving section.

14) A communication tool according to any one of items 1-13, wherein the reproduction means has at least one of a forwarding function, a pausing function, a slow replay function, a reverse function, and a repeat function.

15) A communication support system characterized by comprising: (a) a communication tool comprising: (i) a moving section; (ii) a transmitting information storage means for storing information relating to the moving section directly moved by a user; and (iii) a transmission means for transmitting the stored information in the transmitting information storage means; and (b) a terminal device comprising: (I) a receiving means for receiving the information transmitted from the communication tool; (II) a received information storage means for storing the information received with the receiving means; (III) an image production means for producing a moving image based on the information stored in the received information storage means; and (IV) an image display means for displaying the image produced with the image production means.

16) A communication support system characterized by comprising: (a) a communication tool comprising: (i) a moving section; (ii) a storage means for storing information relating to the moving section directly moved by a user; (iii) a reproduction means for moving the moving section based on the information stored in the storage means; and (iv) a transmission means for transmitting the stored information in the storage means; and (b) a terminal device comprising: (I) a receiving means for receiving information transmitted from the communication tool; (II) a received information storage means for storing the information received with the receiving means; and (III) a transfer means for transferring the information stored in the received information storage means to the storage means of other communication tools.

17) A communication support system characterized by comprising: (a) a communication tool comprising: (i) a moving section; (ii) a storage means for storing information relating to the location of the moving section directly moved by a user; (iii) a reproduction means for moving the moving section based on the information stored in the storage means; and (iv) a transmission means for transmitting the identification information of the user and the password with the information stored in the transmitting information storage means; and (b) a server comprising: (I) a receiving means for receiving the information transmitted from the communication tool; (II) a user identification means for verifying the identification information and the password based on the information received by the receiving means; (II) a received information storage means for storing the information received with the receiving means and accounting information when the user identification means verifies that the identification information and the password are correct; and (IV) a transfer means for transferring the information stored in the received information storage means to a terminal device.

In item 1, the moving section may perform any movement, and the number of the section may be one or plural. Information that makes the transmission means transmit relating to the moving section may be such that the reproduction means move the moving section, for example, information indicating which, how fast, what route, and where the moving section moves can be included. Furthermore, the transmitting information storage means and the received information storage means may be constructed with different storage means or at different storage area in the same storage means.

In item 2, a method for informing the receiving may be any type of methods, for example, that informs visually by moving with specific movements or lighting up a specific light and also informs with specific sounds.

In item 3, the specific movement of the user includes a switch operation for operating specific switch, a gesture command, a voice command, a touch sense command, a visual sense command (the colored small tool use) and so on.

In item 4, the timing of the transmitting the execution command may be that the command is transmitted with information stored in the storage means or after transmitting the information.

In item 5, the autonomous mode is a mode that makes a communication tool operate autonomously like a creature, and the expression transmission mode is a mode that the user operates so that the user can use it in communications.

Further, in item 9, the information with regard to a peripheral environment may be any kind of information if it relates to the peripheral environment; for example, temperature or brightness can be included.

In item 10, when information with regard to the user's gesture is acquired, it is preferable to allow the user to gesture with small tools that have pictorial characteristics, and therefore, information with regard to the gestures can be acquired easily.

In item 13, the forwarding function is for moving the moving section faster than at storing, and the pausing function is for temporally stopping the moving section, and the slow replay function is for moving the moving section slower than at storing. Furthermore, the reverse function is for moving the moving section in the opposite sequence from at storing, and the repeat function is for repeatedly moving the moving section with the movements stored in the storage means.

In item 15, the moving image may be any shape, so that it may be the replicative profile of a communication tool and other configurations.

As explained above, the communication tool relating to item 1 of the present invention first stores and transmits information with regard to the moving section indicating which, how fast, what route, where the moving section moves as the user directly and manually moves any moving section of the communication tool. Next, the other communication tool receiving the transmitting information stores the information and moves the moving section based on the information to reproduce the stored movement. In this manner, since the present invention is a substantial communication tool that transmits the information with regard to the moving section to reproduce the movements, the user can communicate with actual and rich feelings.

Also, since the communication tool relating to item 2 of the present invention is adapted to notify the reception of the transmitting information, the user can easily know the receiving of the above information.

Furthermore, since the communication tool relating to item 3 of the present invention is adapted to move the moving section based on the stored information when it receives the information and detects the specific movement of the user, the user can start the movement easily by only performing the specific movement.

Since the communication tool relating to item 4 of the present invention is adapted to move the above moving section based on the information stored in the above storage means when it receives the execution command, the user can start the movement at desired timing by only transmitting the execution command.

Furthermore, since the communication tool relating to item 5 of the present invention is adapted to be capable of switching the autonomous mode and the expression transmission mode, it can amuse the user by behaving as a pet in the autonomous mode.

Since the communication tool relating to item 6 of the present invention is adapted to switch to the expression transmission mode when the information is received, the user can easily realize the reception of the information.

Furthermore, since the communication tool relating to item 7 of the present invention is adapted to start the transmission to the above transmission means based on commands of the user, the user can transmit information easily.

The communication tool relating to item 8 of the present invention first stores information with regard to the position of the moving section into the storage means when the user manually and directly moves any moving section of the communication tool. Next, it is assumed that the user removes the above storage means and hands it to the other user to allow to be installed in the other communication tool. Then, the other communication tool described above moves the moving section based on the information stored in the above storage means and reproduce the movement stored in the above storage means. In this manner, since the present embodiment is a substantial communication tool that stores and reproduces the movements, the user can communicate with actual and rich feelings.

It is also preferable that the present invention may not only be used in communication by handing to the other user, but also reproduce to enjoy the same movement that itself has directly operated the communication tool to store in the past.

Furthermore, since the communication tool relating to item 9 of the present invention is adapted to store and transmit information in relation to the peripheral environment such as temperatures or brightness, when the other communication tool receiving the transmitted information moves the above moving section based on the received information, motions corresponding to the peripheral environment can be added, for example, shaking motions are added during the operation in the cold place, so that the user can communicate with more actual and richer feelings.

Since the communication tool relating to item 10 of the present invention is adapted to allow the user to gesture with gloves having pictorial characteristics such as a red or green color and acquire to store information in relation to the user's gesture with the image processing device and the like, the user can store the transmitting information easily.

Furthermore, since the communication tool relating to item 11 of the present invention is adapted to store and transmit information in relation to feelings of the user, when the other communication tool receiving the transmitted information moves the moving section based on the received information, the movements depending on the feelings of the user can be added, for example, an angry movement can be added when the tool is angrily moved, so that the user can communicate with more actual and richer feelings.

Since the communication tool relating to item 12 of the present invention is adapted to store and transmit music data and make the other communication tool that receives the music data reproduce the music data, as well as to operate the above moving section, the moving section can be moved to dance to music, for example.

Since the communication tool relating to item 13 of the present invention is adapted to store and transmit voices and make the other communication tool that receives the voices reproduce the voices, as well as to operate the above moving section, the tool can make a bow with a voice, for example “I'm sorry”, and the user can communicate with more actual and richer feeling.

The present invention includes the following embodiments, but is not limited thereto.

Referring now to the drawings, the following example will be described for the construction of the communication support system being capable of using to communicate between separated locations with a communication tool of the present invention.

FIG. 1c is a block diagram, showing entire constitution of the communication support system of this embodiment.

The communication support system of this embodiment comprises, as shown in FIG. 1c, a terminal device 2 (such as a personal computer or a cellular phone) connectable to the predetermined communication line 1 and a communication robot 3 having a communication interface 100 connectable to the terminal device 2 through a radio communication equipment or the like.

The communication robot 3 comprises a communication control section 101, an input device 102, a recognition section 103, a mode switching control section 104, a mode switching device 105, a behavior control section 106, an expression data storage section 107, a removable storage device control section 108, a removable storage device interface 109, an expression transmission operating device 110, a motion device control section 111, an expression database 112 of feelings, and a motion device 113.

The behavior control section 106 comprises an expression transmission control section 114 and an autonomous behavior control section 115, and also, the expression transmission control section 114 comprises an expression input control section 116, an expression output control section 117, and an expression reproduction control section 118.

At first, the communication control section 101 receives information transmitted from other communication robot 3 to input a switching signal into the mode switching control section 104 and to input expression data into the expression data storage section 107.

The input device 102 detects various information such as images, sound, touch senses, environmental information (such as obstacles, temperature, brightness), time, and internal states to input them into the recognition section 103.

The recognition section 103 recognizes gestures, movements of the object, movements of the hands, feet, and the head, user identification, feelings of the user, speeches, touch sense states, and environments to input those recognition results into the autonomous behavior control section 115, based on information input from the input device 102.

The mode switching control section 104 generates a switching command for switching an autonomous mode operating as a pet robot and a expression transmission mode operating as a communication robot to input it into the behavior control section 106, based on the switching signal that is input from the mode switching device 105 having a system user directly perform the switching command of the operating mode and the switching signal that is transmitted from the other communication robot 3 and input by the communication control section 101.

The behavior control section 106 is adapted to generate expression data with the expression input control section 116 of the expression transmission control section 114 to write it to the expression data storage section 107, based on the recognition result input from the recognition section 103 and the switching command input from the mode switching control section 104.

The expression transmission control section 114 generates a write command with the expression output control section 117 to input it into the removable storage device control section 108 and generates a transmission command to input it into the communication control section 101, based on an operating command that has a system user operate the expression transmission and is input from the expression transmission operating device 110.

The removable storage device control section 108 is adapted to write the expression data stored in the expression data storage section 107 to the removable storage device 119 attached to the removable storage device interface 109, based on the write command input from the expression input control section 116.

The communication control section 101 transmits expression data stored in the expression data storage section 107 to the other communication robot 3, based on the transmission command input from the expression output control section 117.

The expression transmission control section 114 generates a read command with the expression reproduction control section 118 to input it into the removable storage device control section 108, based on the operating command input from the expression transmission operating device 110.

The removable storage device control section 108 is adapted to read expression data stored in the removable storage device 119 attached to the removable storage device interface 109 and write it into the expression data storage section 107, based on the read command input from the expression reproduction control section 118.

The communication control section 101 is adapted to automatically write expression data received from the other communication robot 3 to the expression data storage section 107.

The behavior control section 106 is adapted to generate behavior command information in the expression reproduction control section 118 and the autonomous behavior control section 115 to input it into the motion device control section 111, based on the recognition result in the recognition section 103 and the switching command input from the mode switching control section 104.

The motion device control section 111 generates a motion output control signal to input it into the motion device 113, based on behavior command information input from the autonomous behavior control section 115 or the expression reproduction control section 118 and the expression database 112 of feelings.

The motion device 113 controls hands, feet, and the head (not shown) and sounds, light, the display, and the like, based on the motion output control signal input from the motion device control section 111.

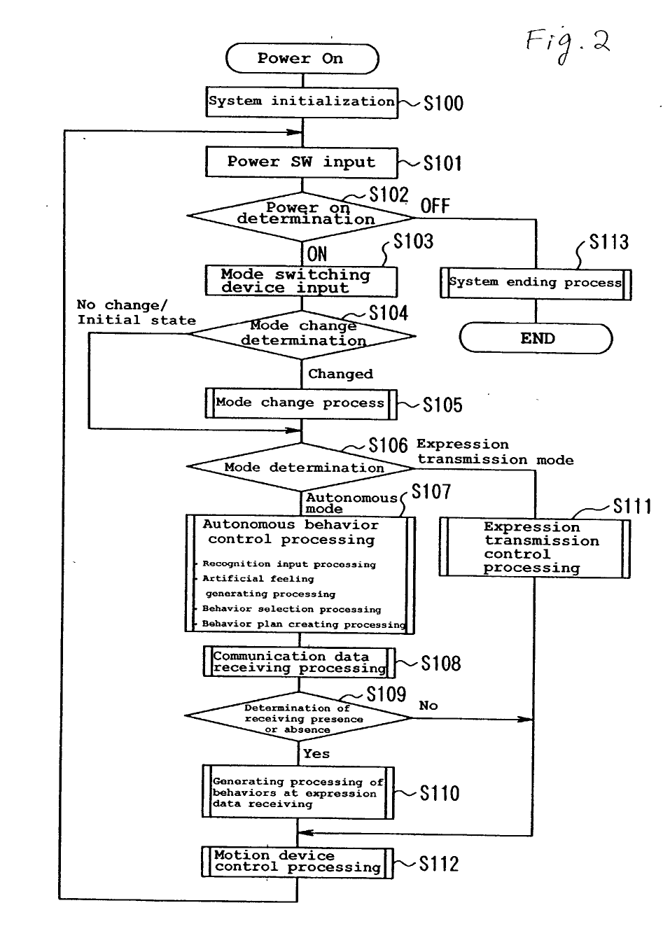

A control program that is executed when the power supply switch is turned on will be described as follows. An arithmetic processing of this control program is for activating the communication robot 3, and at first it shifts the stage to the step S100 as shown in a FIG. 2 when it is executed.

In the step S100, a system initialization is executed, and then the stage is shifted to the step S101.

In the step S101, the state of the power supply switch is read, and then the stage is shifted to the step S102.

In the step S102, the power supply is adapted to be determined if it is turned off, based on the state of the power supply switch being read in the step S101, and the stage will be shifted to the step S110 if the power supply is turned off (OFF) or to the step S103 if not (ON).

In the step S103, a switching signal output from the mode switching device 105 is read, and then the stage is shifted to the step S104.

In the step S104, the operating mode is determined if it is changed based on the switching signal read in the step S103, the stage will be shifted to the step S105 if there is a change (“Changed”), or it will be directly shifted to the step S106 if not (“No change/Initial state”).

In the step S105, a mode change process is executed, and then the stage is shifted to the step S106.

In the step S106, the current operating mode is adapted to be determined based on the switching signal read in the step S103, the stage will be shifted to the step S107 when the mode is in the autonomous mode (“Autonomous mode”), or it will be shifted to the step S111 when the mode is in the expression transmission mode (“Expression transmission mode”).

In the step S107, the autonomous behavior control process is executed, and the stage is shifted to the step S108.

In the step S108, the communication data receiving process is executed, and the stage is shifted to the step S109.

In the step S109, it is adapted to be determined whether information or the like is received from the other communication robot 3, the stage will be shifted to the step S110 when it is received (“Yes”) or it will be directly shifted to the step S112 if not (“No”).

In the step S112, the motion generating process is executed in the expression data receiving, and then the stage is shifted to the step S112.

On the other hand, in the step S111, the expression transmission control process described below is executed, and then the stage is shifted to the step S112.

In the step S112, the motion device control process is executed, and then arithmetic processing of this control program is terminated.

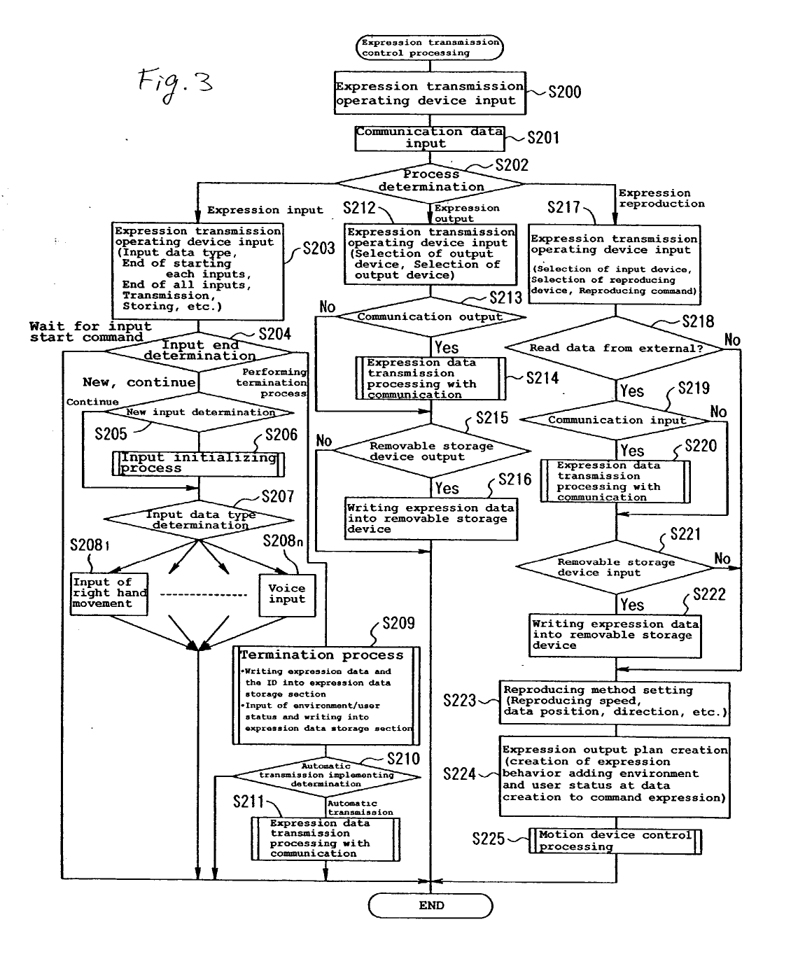

Referring to a flowchart of FIG. 3, the expression transmission control process executed in the step S111 for the arithmetic processing of the above control program will be described in detail as follows.

At first, in the step S200, a type of the process that a system user is prompted to input with the expression transmission operating device 110 is read, and then the stage is shifted to the step S201. As for the type of the process, there are an expression input process for storing expression data into the expression data storage section 107, an expression output process for passing the expression data stored in the expression data storage section 107 to the other communication robot 3, and an expression reproduction process for operating the motion device 113 based on the expression data stored in the expression data storage section 107.

In the step S201, information transmitted from the other communication robot 3 is read through the communication interface 100, and the stage is shifted to the step S202.

In the step S202, the executing process is determined based on the information read in the above step S200, and the stage would be shifted to the step S203 when the expression input process is selected (“Expression input”), the stage would be shifted to the step S208 when the expression output process is selected (“Expression output”), or the stage would be shifted to the step S216 when the expression reproduction process is selected (“Expression reproduction”).

In the step S203, the type of input data, start or end of each input, the end of all inputs, transmission, storage, and so on are prompted to be input from the expression transmission operating device 110, and the stage is shifted to the step S204.

In the step S204, this expression transmission control process determination is adapted to be directly terminated at the input start command waiting (“Waite for input start command), but the stage is shifted to the S205 at the new start or continuation (“New, Continue”), or it is shifted to the step S220 when it is terminated (“Performing termination process”).

In the step S205, the new input is adapted to be determined, the stage would be shifted to the step S206 at the new input or it would be directly shifted to the step S112 if not (“Continue”).

In the step S206, the input initialization process is executed, and then the stage is shifted in the step S207.

In the step S207, an input data type is adapted to be determined, a step in response to the type of input data within the range between a step S208ₗ, to S208ₙ, is executed such that the stage would be shifted to the step S208ₗ when the motion of a right hand is input and to S208ₙ when the voice is input, and then the expression transmission control process is terminated.

On the other hand, in the step S209, the termination process is executed, and then the stage is shifted to the step S210.

In the step S210, it is adapted to be determined whether the automatic transmission is executed or not, and the stage will be shifted to the step S211 when the automatic transmission is executed (“Automatic transmission”), or the expression transmission control process will be directly terminated if not.

In the step S211, the communication data transmission process is executed, and then the expression transmission control process is terminated.

On the other hand, in the step S212, an output device for transmitting or transferring the expression data to the other communication robot 3 is prompted to be selected with the expression transmission operating device 110, as well as which expression data stored in the expression data storage section 107 is output is selected, and then the stage is shifted to the step S213.

In the step S213, it is adapted to be determined whether the expression data selected in the step S212 is transmitted through the communication line 1 or not, based on the selected result in the step S212, and the stage will be shifted to the step S214 when it is transmitted (“Yes”) or directly to the step S215 if not (“No”).

In the step S214, the expression data transmission process by the communication is executed, and the stage is shifted to the step S215.

In the step S215, it is adapted to be determined whether the expression data selected in the step S212 is transferred or not, based on the selected result in the step S212, and the stage will be shifted to the step S216 when it is transferred (“Yes”), or the expression transmission control process is directly terminated if not (“No”).

In the step S216, the expression data selected in the step S212 is read from the expression data storage section 107, as well as it is written in the removable storage device 119 attached to the removable storage device interface 109, and then the expression transmission control process is terminated.

On the other hand, in the step S217, an input device for receiving the expression data from the other communication robot 3 or transferring from the removable storage device 119 is prompted to be selected with the expression transmission operating device 110, as well as which expression data stored in the expression data storage section 107 is reproduced is selected, and then the stage is shifted to the step S218.

In the step S218, it is determined whether the data is externally read or not, based on the selected result of the input device being input in the step S217, and the stage will be shifted to the step S219 when it is read (“Yes”) or to the step S223 if not.

In the step S219, it is adapted to be determined whether the expression data is received through the communication line 1 or not, based on the selected result of the input device being input in the step S217, and the stage will be shifted to the step S220 when it is received (“Yes”) or directly to the step S221 if not (“No”).

In the step S220, the expression data receiving process through the communication is executed, and the stage is shifted to the step S221.

In the step S221, it is adapted to be determined whether the expression data is transferred from the removable storage device 119 or not, based on the selected result of the input device being input in the step S217, and the stage will be shifted to the step S214 when it is transferred (“Yes”) or directly to the step S215 if not (“No”).

In the step S222, the expression data is read from the removable storage device 119, and the stage is shifted to the step S223.

In the step S223, the reproduction methods such as the reproduction speed or data position or direction are set, and the stage is shifted to the step S224.

In step S224, the expressing motion that is added the environment or user status during the data preparation into the command expression is prepared, and the stage is shifted to the step S225.

In the step S225, the motion device control process is executed, and then the expression transmission control process is terminated.

According to the above flow, when the expression input process is selected in the step S202, expression data showing the movements of the motion device 113 that are manually and directly moved by the system user in the steps S203-S211 is generated and stored in the expression data storage section 107.

Subsequently, when the expression output process is selected in the step S203, expression data stored in the expression data storage section 107 is transmitted to the other communication robot 3 in the steps S212-S216.

When the expression reproduction is selected with step S202, the motion device 113 is moved, based on the information stored in the expression data storage section 107, and the movement or the like stored in the expression data storage section 107 is reproduced.

In this manner, since the communication robot 3 of the present embodiment is a substantial communication tool that transmits the expression data to reproduce the movement and the like, the user can communicate with actual and rich feelings.

Because the present embodiment is adapted to store and receive voices into the expression data storage section 107 and make the other communication robot 3 that receives the voices reproduce the voices, as well as to operate the motion device 113, the robot can make a bow with a voice, for example “I'm sorry”, and the user can communicate with more actual and richer feeling.

Furthermore, since the present embodiment is adapted to start the transmission to the communication control section 101 based on commands of the user, the user can transmit information easily.

When the expression input process is selected in the step S202 to store the expression data in the expression data storage section 107, and then the expression reproduction is selected in the step S202, the motion device 113 is moved based on the information stored in the expression data storage section 107, and the movement or the like stored in the expression data storage section 107 is reproduced.

In this manner, the communication robot 3 of this embodiment not only reproduces the expression data transmitted from the other communication robot 3, but also entertains the user by reproducing the movement that is stored by directly operating the communication robot 3 with itself in the past.

In this embodiment, the moving section corresponds to the motion device 113, the transmitting information storage means and the received information storage means correspond to the expression data storage section 107, the transmission means and the receiving means correspond to the communication control section 101, the reproduction means corresponds to the motion device control section 111, the voice recording means corresponds to the input device 102, the voice reproduction means corresponds to the motion device 113, and the transmission commanding means corresponds to the expression transmission operating device 110.

Furthermore, the above embodiment shows the example of the communication robot 3 related to the present invention and is not limited to an opportunity of the movement start or details of the expression data.

For example, when the expression data is received, and the specific movement of a user is detected, the motion device 113 may be operated based on the expression data stored in the expression data storage section 107, and it is preferable because the user can easily start the movement.

Furthermore, when the execution command is received, for example, the motion device 113 may be operated based on the expression data stored in the expression data storage section 107, and the user can starts the movement at desired timing.

For example, the receiving the expression data from the other communication robot 3 may be notified with the specific movement, and if it is done, the user can easily know the receiving of the above information.

Furthermore, information in relation to the peripheral environment such as temperatures or brightness may be stored in the expression data storage section 107 to add motions corresponding to the peripheral environment in the movement of the motion device 113 based on the expression data stored in the expression data storage section 107, for example, when shaking motions are added during the movement in the cold place, the user can communicate with more actual and richer feelings.

The present invention exhibits at least the following effects:

As discussed above, the communication tool of the present invention comprises the transmitting information storage means storing information in relation to the moving section directly moved by the user, the transmission means for transmitting the stored information in the transmitting information storage means, and the reproduction means for moving the moving section based on the information transmitted from the other communication tool, and it is a substantial communication tool for transmitting to reproduce the motion that the moving section in the other communication tool moves as the user directly moves it with the hands, so that the user can communicate with actual and rich feelings.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A communication tool comprising:
a motion device which is physically movable by a user and provides signals corresponding to its movement;
a transmitting information storage for storing the signals;
a transmitter for transmitting the signals stored in the transmitting information storage to another communication tool;
a receiver for receiving signals transmitted from another communication tool;
a received information storage for storing the received signals by the receiver; and
a motion reproduction unit for activating the motion device based on the received signals stored in the received information storage.

2. The communication tool according to claim 1, further comprising a behavior control unit provided a position between the motion device and the transmitting information storage, between the motion reproduction unit and the received information storage, between the transmitter and the transmitting information storage, and between the receiver and the receiving information storage, so that all signals pass through the behavior control unit which controls flow of the signals.

3. The communication tool according to claim 2, further comprising an environment detection unit for detecting environmental information including the user's designated motion, said environment detection unit being connected to the behavior control unit, said behavior control unit being configured to activate the motion reproduction unit when the user's designated motion is detected.

4. The communication tool according to claim 2, further comprising an environment detection unit for detecting environmental information including signals inputted by the user, said environment detection unit being connected to the behavior control unit, said behavior control unit being configured to activate the motion reproduction unit when the user's signals are received.

5. The communication tool according to claim 2, further comprising an environment detection unit for detecting environmental information including ambient, temperature and brightness, said environment detection unit being connected to the behavior control unit, said behavior control unit being configured to transmit the environmental information.

6. The communication tool according to claim 2, further comprising a mode selection unit for selecting an autonomous mode for activating the motion reproduction unit autonomously or an expression transmission mode for following the user's commands, wherein the behavior control unit includes the autonomous mode and the expression transmission mode.

7. The communication tool according to claim 6, further comprising an operation command input unit for selecting one operation from (i) signal receiving processing, (ii) signal transmitting processing, or (iii) motion reproduction processing, in the expression transmission mode, wherein the expression transmission mode of the behavior control unit includes the signal receiving processing, the signal transmitting processing, and the motion reproduction processing.

8. The communication tool according to claim 2, wherein the behavior control unit is configured to output information stored in the transmitting information storage to the motion reproduction unit to move the motion device.

9. The communication tool according to claim 2, wherein the behavior control unit is configured to access an external memory unit to save information stored in either of the transmitting information storage or the received information storage or provide information to either of the transmitting information storage or the received information storage.

10. A communication method comprising:
physically manipulating a motion device by a user, said motion device providing signals corresponding to its movement;
for storing the signals in a transmitting information storage;
transmitting the stored signals to another communication tool;
receiving signals transmitted from another communication tool;
storing the received signals in a received information storage; and
activating the motion device based on the received signals stored in the received information storage.

11. A communication tool characterized by comprising:
a moving section;
a transmitting information storage means for storing information relating to the moving section directly moved by a user;
a transmission means for transmitting the information stored in the transmitting information storage means;
a receiving means for receiving the information transmitted from other communication tools;
a received information storage means for storing the information received by the receiving means; and
a reproduction means for moving the moving section based on the information stored in the received information storage means.

12. The communication tool according to claim 11, wherein the receiving means comprises a reception notifying means for notifying that the receiving means received the information.

13. The communication tool according to claim 11, comprising a detection means for detecting the specific movement of the user, wherein the reproduction means is adapted to move the moving section based on the information stored in the received information storage means, when the receiving means receives the information and when the detection means detects the specific movement.

14. The communication tool according to claim 11, wherein the transmission means is adapted to transmit an execution command, and the reproduction means is adapted to move the moving section based on the information stored in the received information storage means when the receiving means receives the execution command.

15. The communication tool according to claim 11, further comprising a mode switching means for selectively switching an autonomous mode and an expression transmission mode.

16. The communication tool according to claim 15, wherein the mode switching means is adapted to switch to the expression transmission mode when the receiving means receives the information.

17. The communication tool according to claim 11, further comprising a transmission commanding means for making the transmission means start transmission based on a command of the user.

18. A communication tool characterized by comprising:
a moving section;
a storage means for storing information relating the moving section directly moved by a user; and
a reproduction means for moving the moving section based on the information stored in the storage means.

19. The communication tool according to claim 11 or 18, further comprising an environmental information acquisition means for acquiring information relating to a peripheral environment, wherein the transmitting information storage means is also adapted to store the information acquired by the environmental information acquisition means.

20. The communication tool according to claim 11 or 18, further comprising a gesture information acquisition means for acquiring information relating to the gestures of the user, wherein the transmitting information storage means is also adapted to store the information acquired by the gesture information acquisition means.

21. The communication tool according to claim 11 or 18, comprising a feeling information acquisition means for acquiring information relating to feelings of the user, wherein the transmitting information storage means is also adapted to store the information acquired by the feeling information acquisition means.

22. The communication tool according to claim 11 or 18, further comprising a music reproduction means capable of reproducing music data, wherein the transmitting information storage means is adapted to store the music data, and the reproduction means is adapted to make the music reproduction means reproduce the music data as well as move the moving section, based on the information stored in the received information storage means.

23. The communication tool according to claim 11 or 18, further comprising a voice recording means for recording the voice spoken by the user and a voice reproduction means capable of reproducing the voice, wherein the transmitting information storage means is also adapted to store the voice recorded with the voice recording means, and the reproductopn means is adapted to make the voice reproduction means reproduce the voice based on information stored in the received information storage means as well as to move the moving section.

24. The communication tool according to claim 11 or 18, wherein the reproduction means has at least one of a forwarding function, a pausing function, a slow replay function, a reverse function, and a repeat function.

25. A communication support system characterized by comprising:
a communication tool comprising:
a moving section;
a transmitting information storage means for storing information relating to the moving section directly moved by a user; and
a transmission means for transmitting the stored information in the transmitting information storage means; and
a terminal device comprising:
a receiving means for receiving the information transmitted from the communication tool;
a received information storage means for storing the information received with the receiving means;
an image production means for producing a moving image based on the information stored in the received information storage means; and
an image display means for displaying the image produced with the image production means.

26. A communication support system characterized by comprising:
a communication tool comprising:
a moving section;
a storage means for storing information relating to the moving section directly moved by a user;
a reproduction means for moving the moving section based on the information stored in the storage means; and
a transmission means for transmitting the stored information in the storage means; and
a terminal device comprising:
a receiving means for receiving information transmitted from the communication tool;
a received information storage means for storing the information received with the receiving means; and
a transfer means for transferring the information stored in the received information storage means to the storage means of other communication tools.

27. A communication support system characterized by comprising:
a communication tool comprising:
a moving section;
a storage means for storing information relating to the location of the moving section directly moved by a user;
a reproduction means for moving the moving section based on the information stored in the storage means; and
a transmission means for transmitting the identification information of the user and the password with the information stored in the transmitting information storage means; and
a server comprising:
a receiving means for receiving the information transmitted from the communication tool;
a user identification means for verifying the identification information and the password based on the information received by the receiving means;
a received information storage means for storing the information received with the receiving means and accounting information when the user identification means verifies that the identification information and the password are correct;and
a transfer means for transferring the information stored in the received information storage means to a terminal device.
